(19) United States
(12) Patent Application Publication
(10) Pub. No.: US 2005/0206295 A1
(43) Pub. Date: Sep. 22, 2005

(54) Display device

(76) Inventors: Yukio Suzuki, Mobara (JP); Sachio Koizumi, Mobara (JP)

Correspondence Address: Christopher E. Chalsen;Milbank, Tweed, Hadley & McCloy LLP, 1 Chase Manhattan Plaza, New York, NY, 10005-1413, US

(21) Appl. No.: 11/080,811

(22) Filed: Mar. 14, 2005

(30) Foreign Application Priority Data
Mar. 17, 2004 (JP) 2004-076519

(51) Int. Cl. H01J 29/89; H01J 29/10; H01J 29/88; H01J 1/62; H01J 63/04

(52) U.S. Cl. 313/479; 313/478; 313/461

(57) ABSTRACT

The present invention provides a display device which can suppress a gas emission in the inside of a vacuum envelope. A display device of the present invention includes a vacuum envelope which has a panel which forms a phosphor screen on an inner surface thereof, an electron source device, and a connecting portion which connects the panel and the electron source device. The phosphor screen includes phosphor pixels, a black matrix which surrounds the phosphor pixels and a metal thin film which covers the black matrix film and the phosphor pixels, and the connecting portion includes a conductive film on an inner surface thereof. At least one of the phosphor pixels, the black matrix and the conductive film contains boron so as to suppress the gas emission in the inside of the vacuum envelope.

### BACKGROUND OF THE INVENTION

The present invention relates to a display device provided with a vacuum envelope, and more particularly to a display device which suppresses the emission of gas in the inside of the vacuum envelope.

As display devices, there have been proposed various types of display devices including, for example, various types of cathode ray tubes such as a television receiver set or a display tube and flat-panel-type display devices such as a plasma display panel, a liquid crystal display device, a vacuum fluorescent display (VFD), a field emission type display device (FED) which includes field emission electron sources on a flat plate thereof.

Among these display devices, as the display device which includes a vacuum envelope, there has been known the above-mentioned cathode ray tube, the above-mentioned vacuum fluorescent display, a surface conductive field emission type display device, the above-mentioned field emission type display device and the like and these display devices respectively have excellent features.

Since the cathode ray tube has the image reproducibility of high definition, the cathode ray tube has been popularly used as display means of various types of information processing equipment.

Further, the flat-panel-type display device such as the field emission type display device is constituted of two flat panels which face each other in an opposed manner and hence, the display device has several advantages including an advantage that a depth size thereof can be made remarkably small compared to a depth size of the conventional cathode ray tube thus realizing a light-weighted and thin display device.

Among these display devices having the vacuum envelope, the conventional cathode ray tube includes a panel portion which is provided with a phosphor screen on which phosphor pixels, a black matrix film (hereinafter referred to as “BM layer”) which surrounds the phosphor pixels and a metal thin film which covers the BM layer and the phosphor pixels are formed on an inner surface thereof, a neck portion which houses an electron gun having a plurality of electrodes which generate and emit the electron beams toward the phosphor screen, and a funnel portion which connects the panel portion and the neck portion to constitute a vacuum envelope. The funnel portion includes an interior conductive film on an inner wall surface. A main component of the BM layer and the interior conductive film is graphite. Further, the conventional cathode ray tube is configured to exteriorly mount a deflection yoke which is provided for allowing the electron beams emitted from the electron guns to scan on the phosphor screen thereon.

In such a cathode ray tube, the interior conductive film has a conductive function of applying a high voltage to the phosphor screen, the electron gun and the like, a function of absorbing secondary electrons, a function of absorbing a gas inside the tube and the like. Further, the interior conductive film contains graphite as a main component. The interior conductive film also contains potassium silicate which has a function of increasing a film strength as well as a function of increasing adhesiveness with a funnel glass, titanium oxide provided for adjusting a resistance value of the film, other organic substances and the like.

Further, the interior conductive film of this type of cathode ray tube is disclosed in, for example, JP-B-64-5741 (patent literature 1) and JP-A-4-43374 (patent literature 2)

The patent literature 1 discloses a technique in which an interior conductive film includes a high-resistant graphite film which is applied to an inner wall surface of a funnel portion, a high-voltage introducing member which is arranged to be brought into contact with the graphite film, and a low-resistant graphite film which is provided in the vicinity of a portion where the high-resistant graphite film is brought into contact with the high-voltage introducing member and has a lower resistance value than the high-resistant graphite film, the high-resistant graphite film is formed of titanium oxide, graphite and water glass and has a specific resistance thereof set to 1 to 1000Ω·cm, the low-resistant graphite film is formed of titanium oxide, graphite and water glass or graphite and water glass and has a specific resistance thereof set to 0.001 to 0.4Ω·cm whereby an in-tube emission can be prevented and the occurrence of conductive failure can be totally eliminated.

Further, the patent literature 2 discloses a technique in which a conductive film which is applied to an inner wall surface of a funnel portion is mainly composed of graphite, water glass and titanium oxide, and the specific resistance is set by changing a mixing ratio of titanium oxide in response to functions such as the reduction of a spark current value, the abrasion resistance, the gas absorbing ability and the like to form a high resistant portion having the specific resistance of 1 to 10Ω·cm which is positioned at an intermediate portion between an anode button and an electron gun, a low resistant portion having the specific resistance of 0.1 Ω·cm or less which is positioned on a panel portion side, and an intermediate resistant portion having the specific resistance of 0.1 to 1 Ω·cm which is positioned at a neck portion having a bulb spacer contact, whereby a soft flash tub having the excellent dielectric strength and lifetime characteristics and the like can be realized.

Further, the patent literature 2 also discloses that the interior conductive film does not use iron oxide and hence, it is unnecessary to take any countermeasures to cope with halogen.

On the other hand, with respect to the above-mentioned FED which is one of flat-panel-type display devices, as disclosed in JP-A-2002-358915 (patent literature 3), a vacuum envelope is constituted by laminating a face substrate and a back substrate with side walls (a sealing frame) inserted therebetween and evacuating the inside of the laminated structure. In the inside of the vacuum envelope, a plurality of support members (spacers) is arranged within a region surrounded by the side walls to support an atmospheric-pressure load which acts on the above-mentioned both substrates. Further, a gap between the face substrate and the back substrate is set to several mm.

To maintain a high vacuum in the inside of the vacuum envelope, in the patent literature 3, there is a description that a height of the spacers is set smaller than a height of the side walls and hence, the reliability of sealing property of the side walls and both substrates is ensured whereby the high vacuum is held in the inside of the vacuum envelope thus providing an image display device which exhibits the excellent display performance.

### SUMMARY OF THE INVENTION

Along with a strict demand for the large-sizing, the higher performance and the prolonged lifetime, it is indispensable for the display device to maintain a high vacuum in the inside of the vacuum envelope.

To maintain the high vacuum in the inside of the vacuum envelope, it is most important to perform the complete evacuation of gas at the time of performing the evacuating operation. However, it is unavoidable that a gas is generated from electrodes or the like which are arranged in the inside of a tube during the operation and hence, the prevention of the deterioration of the degree of vacuum attributed to the emission of gas during the operation is also an indispensable factor.

When the degree of vacuum is degraded during the operation of the display device, a portion of the residual gas in the inside of the vacuum envelope is ionized and this ionized gas impinges on an electron emitting surface thus giving rise to a possibility that the electron emission ability is deteriorated.

It has been known that the in-tube residual gas is generated from many members such as electrodes or the like, phosphors, a BM layer and the like formed in the inside the tube. Particularly with respect to the cathode ray tube, a gas emission quantity from the interior conductive film is large. The interior conductive film is formed such that the film covers a wide range inside the cathode ray tube ranging from the funnel portion to the neck portion.

As disclosed in the above-mentioned patent literature 2, the interior conductive film is expected to perform the function of absorbing the in-tube residual gas and, various studies have been made with respect to the composition, the particle size, the film resistance value including such a function. However, the gas emission quantity still exceeds the gas absorption quantity and hence, it is difficult to completely eliminate the gas emission.

Accordingly, to obtain the prolonged lifetime by reducing the in-tube residual gas, the suppression of the gas emission quantity from members which are arranged inside the tube such as, for example, the phosphor pixels, the BM layer, the interior conductive film and the like has been one of tasks to be solved.

The present invention has been made under such circumstances. The present invention is a display device having a prolonged lifetime by suppressing a gas emission quantity from phosphor pixels, a BM layer and an interior conductive film.

According to the display device of the present invention, at least one of phosphor pixels and a BM layer contains boron.

The present invention is not limited to the above-mentioned constitutions and various modification can be made without departing from the technical concept of the present invention.

### BRIEF DESCRIPTION OF THE DRAWINGS

FIG. 1 is a schematic cross-sectional view showing the schematic constitution of a shadow-mask-type color cathode ray tube for explaining one embodiment of a display device according to the present invention;

FIG. 2 is a schematic cross-sectional view for explaining the constitution of a phosphor screen of the color cathode ray tube shown in FIG. 1;

FIG. 3 is an enlarged cross-sectional view for explaining the constitution of a funnel portion of the color cathode ray tube shown in FIG. 1;

FIG. 4 is a schematic developed perspective view for explaining the schematic constitution of one example of a field emission type display device of another embodiment of a display device according to the present invention;

FIG. 5 is a plan view of a face substrate shown in FIG. 4 as viewed from a back substrate side;

FIG. 6 is a cross-sectional view taken along a line I-I in FIG. 5;

FIG. 7 is a view for explaining a gas emission quantity of a conductive film;

FIG. 8 is a view for explaining a gas emission quantity of a conductive film;

FIG. 9 is a view for explaining an emission gas content of a conductive film of the present invention;

FIG. 10 is a view for explaining an emission gas content of a conventional conductive film;

FIG. 11 is a view for explaining an emission gas content of a conductive film of the present invention; and

FIG. 12 is a view for explaining an emission gas content of a conventional conductive film.

### DETAILED DESCRIPTION OF THE INVENTION

That is, to briefly explain typical inventions among inventions described in this specification, these inventions are as follows.

The present invention is directed to a display device including a vacuum envelope which has a panel which forms a phosphor screen on an inner surface thereof, an electron source device which is provided with an electron source, and a connecting portion which connects the panel and the electron source device, wherein the phosphor screen includes phosphor pixels, a black matrix which surrounds the phosphor pixels and a metal thin film which covers the black matrix and the phosphor pixels, and the connecting portion includes a conductive film on an inner surface thereof, and at least one of the phosphor pixels, the black matrix and the conductive film contains boron.

Further, the present invention is directed a display device including a vacuum envelope which has a panel portion which forms a phosphor screen on an inner surface thereof, a neck portion which is provided with an electron source, and a funnel portion which connects the panel portion and the neck portion, wherein a conductive film is formed on an inner surface of the funnel portion and the inner conductive film contains boron.

Further, the present invention is directed to a display device including a phosphor screen which has phosphor pixels, a black matrix film which surrounds the phosphor pixels and contains graphite as a main component therein and a metal thin film which covers the black matrix film and the phosphor pixels, and electron sources which emit electrons toward the phosphor screen in the inside of a vacuum envelope, wherein at least one of the phosphor pixels or the black matrix film contains boron.

According to the present invention, it is possible to suppress the gas emission from at least one of the phosphor pixels and the BM layer and hence, the deterioration of the degree of vacuum during the operation can be prevented whereby it is possible to prevent electron emission surfaces of cathodes from being damaged thus capable of providing a display device which exhibits a high definition and a prolonged lifetime.

Further, according to the present invention, it is possible to suppress the gas emission from at least one of the phosphor pixels and the BM layer and the interior conductive film of the cathode ray tube and hence, the deterioration of the degree of vacuum during the operation can be prevented whereby it is possible to prevent electron emission surfaces of cathodes from being damaged thus capable of providing a cathode ray tube which exhibits a high definition and a prolonged lifetime.

Further, according to the present invention, it is possible to suppress the gas emission from the interior conductive film and hence, it is possible to shorten an evacuation time thus realizing the enhancement of the operation efficiency and the reduction of a manufacturing cost.

Further, according to the present invention, it is possible to suppress the gas emission from the phosphor pixels and the BM layer which are arranged substantially over the whole inner surface of the face panel of a flat-panel-type display device and have the highest possibility of becoming gas emission sources and hence, the deterioration of the degree of vacuum during the operation can be prevented whereby it is possible to prevent electron emission surfaces of cathodes from being damaged thus capable of providing a flat-panel type display device which exhibits a high definition and a prolonged lifetime.

Further, according to the present invention, the phosphor pixels, the BM layer and the interior conductive film generally have porous surfaces and hence, it is possible to apply boron by spraying, for example, thus exhibiting the excellent operability.

Further, according to the present invention, by adding boron into a slurry for manufacturing the phosphor pixels, the BM layer and the interior conductive film, these members can be simultaneously manufactured with the pixels and the films whereby the operation steps can be shortened.

Further, since boron is present in the whole pixels and film in a mixed state, a further gas emission suppression effect can be expected.

Hereinafter, embodiments of the present invention are explained in conjunction with drawings which illustrate the embodiments.

### Embodiment 1

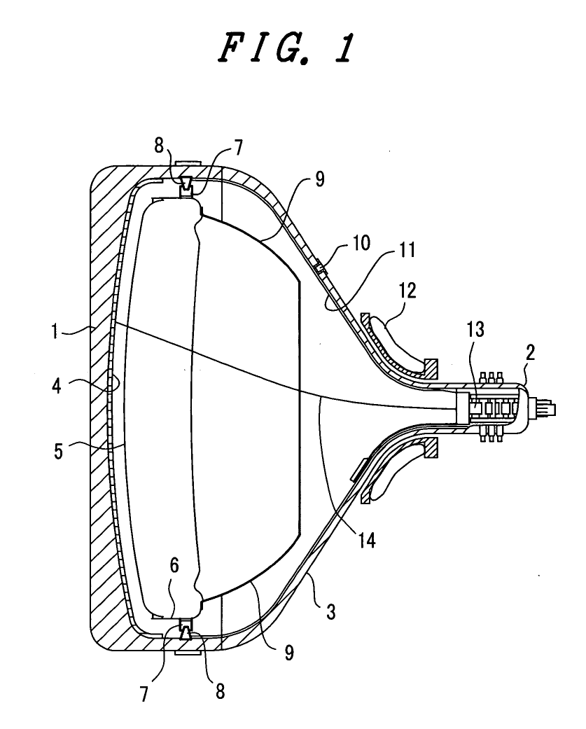

FIG. 1 is a schematic cross-sectional view for explaining the schematic constitution of one example of a shadow mask type color cathode ray tube for explaining one embodiment of a display device of the present invention.

A panel portion 1 is referred to as a flat panel type, wherein a face portion has a flat shape. A funnel portion 3 constitutes a connecting portion for connecting the panel portion 1 and a neck portion 2. A vacuum envelope is constituted by connecting the panel portion 1 and the neck portion 2 using the funnel portion 3. In FIG. 1, numeral 4 indicates a phosphor screen which is formed on an inner surface of the panel portion 1 and has phosphors in three colors consisting of red (R), green (G), blue (B) in general in a mosaic shape or in a stripe shape, while numeral 5 indicates a shadow mask which constitutes a color selecting electrode. The shadow mask 5 is a press-formed self-standing type and has a periphery thereof welded to a mask frame 6 and is supported by stud pins 8 mounted in a suspended manner on an inner wall of a skirt portion of the panel portion 1 in an upright manner by way of suspension springs 7 fixed to the mask frame 6. Here, a magnetic shield 9 which blocks an external magnetic field (earth magnetism) is mounted on an electron gun side of the mask frame 6.

A high voltage introducing terminal 10 is connected with an interior conductive film 11 which is formed on the funnel portion 3 in a state that the interior conductive film 11 covers a region extending from an approximately whole inner surface of the funnel portion 3 to a portion of the neck portion 2 and contains graphite as a main component. A panel-portion-1-side end portion of the interior conductive film 11 is electrically connected with the phosphor screen 4 and the shadow mask 5. A deflection yoke 12 is exteriorly mounted on a neck-funnel transitional region of the vacuum envelope. Further, in the drawing, numeral 13 indicates an electron gun which emits three electron beams. A high voltage is applied to an anode of the electron gun 13 through the interior conductive film 11. The neck portion 2 houses the electron gun 13 and constitutes an electron source device. Numeral 14 indicates the electron beam which represents one electron beam out of three electron beams.

Three electron beams 14 which are emitted from the electron gun 13 are modulated by video signals outputted from an external signal processing circuit not shown in the drawing and are emitted toward the phosphor screen 4. Three electron beams 14 are deflected horizontally (in the X direction) and vertically (in the Y direction) due to horizontal and vertical deflection magnetic fields which are generated by the deflection yoke 12. The deflected electron beams are allowed to perform the secondary scanning on the phosphor screen 4 thus reproducing an image. The shadow mask 5 selects the respective three electron beams 14 which pass through a large number of apertures formed in plane for every color and reproduces a given image.

The cathode ray tube is hermetically sealed after the inside of the tube is evacuated. The degree of vacuum of approximately 10⁻³ to 10⁻⁴ Pa is created in the cathode ray tube immediately after sealing. Thereafter, the degree of vacuum is increased to approximately 10⁻⁵ to 10⁻⁶ Pa by performing getter flashing and aging.

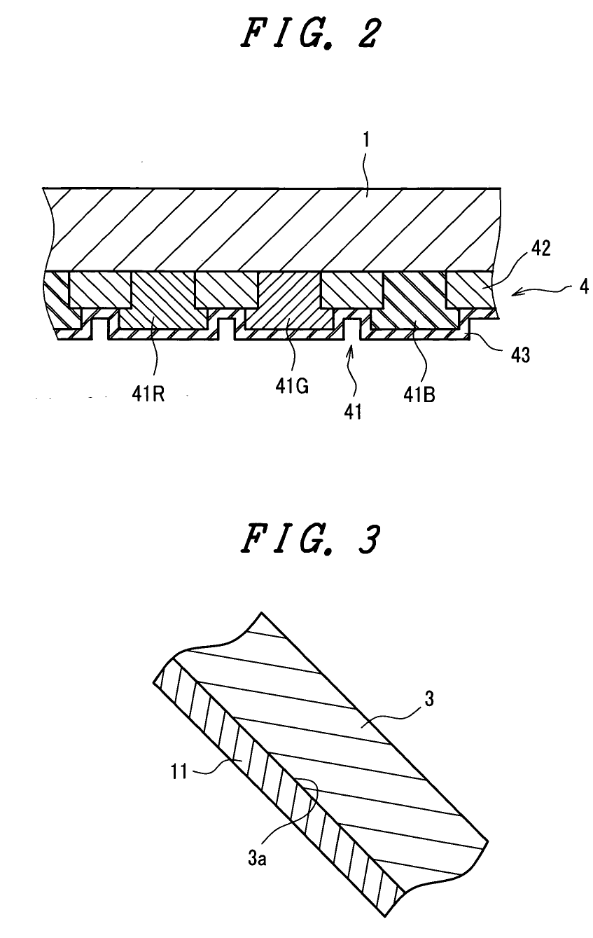

FIG. 2 is an enlarged schematic cross-sectional view for explaining the constitution of the phosphor screen 4 of the color cathode ray tube shown in FIG. 1.

In FIG. 2, the phosphor screen 4 includes phosphor pixel 41 which is formed of a combination of a red phosphor pixel 41R, a green phosphor pixel 41G and a blue phosphor pixel 41B, a BM layer 42 which contains graphite as a main component and surrounds the phosphor pixel 41, and a metal thin film 43 which covers the electron-gun-13 side of the BM layer 42 and the phosphor pixel 41. Further, the phosphor pixel 41 and the BM layer 42 are configured to contain boron. After phosphor pixel 41 and the BM layer 42 are formed, the boron is contained or introduced into the phosphor pixel 41 and the BM layer 42 by immersing the phosphor pixel 41 and the BM layer 42 into an aqueous solution which is produced by diluting boron hydride [B(OH)₃] with pure water or the like.

Further, in the above-mentioned embodiment, although the boron is configured to be contained in both of the phosphor pixel 41 and the BM layer 42, the boron may be formed in either one of the phosphor pixel 41 and the BM layer 42. For example, after forming the BM layer 42, the BM layer 42 may be immersed into the above-mentioned aqueous solution and, thereafter, the phosphor pixel 41 may be formed. Further, to allow only the phosphor pixel 41 to contain the boron, the boron may be formed in the phosphor pixel 41 by preliminarily mixing the boron into a phosphor slurry.

FIG. 3 is an enlarged cross-sectional view for explaining the constitution of the interior conductive film 11 which is applied to the funnel portion 3 of the color cathode ray tube shown in FIG. 1.

In FIG. 3, the interior conductive film 11 is applied to and formed on an inner wall surface 3a of the funnel portion 3, wherein the interior conductive film 11 is configured to contain graphite as a main component. The interior conductive film 11 also contains potassium silicate which has a function of enhancing a film strength and also a function of enhancing the adhesiveness thereof with a funnel glass, titanium oxide which has a function of adjusting a resistance value of the film, other organic substances and boron.

In the cathode ray tube described in this embodiment 1, since at least one of the phosphor pixel and the BM layer and the interior conductive film contain the boron and hence, it is possible to suppress the gas emission from these phosphor pixel and film whereby the deterioration of the cathode attributed to the presence of oxidizing gas can be prevented thus realizing the prolonged lifetime of the color cathode ray tube.

Further, in the embodiment 1, due to the above-mentioned constitution, a gas emission quantity can be suppressed and hence, it is possible to shorten an evacuation time at the time of manufacturing the cathode ray tube thus realizing the enhancement of the operation efficiency and the reduction of a manufacturing cost which is brought about by the enhancement of the operation efficiency.

### Embodiment 2

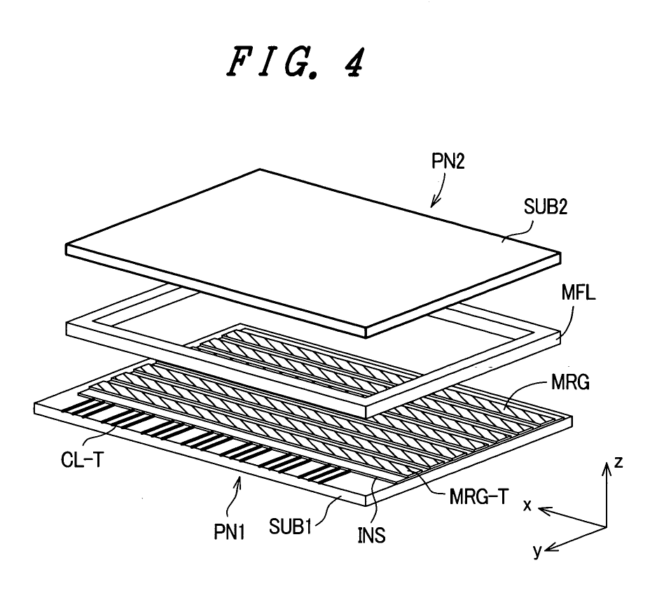

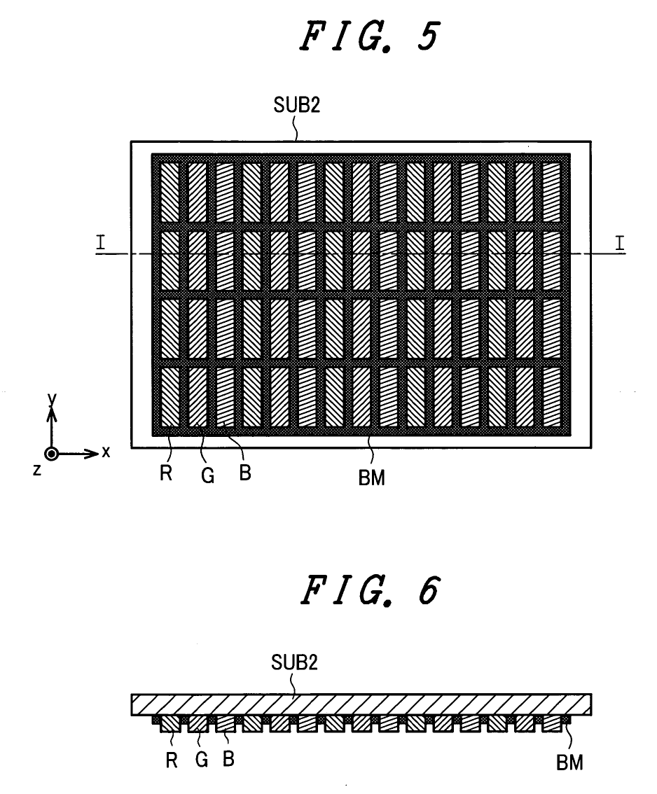

FIG. 4 to FIG. 6 are views for explaining a display device according to the present invention and are schematic constitutional views of a field emission type display device. Here, FIG. 4 is a schematic developed perspective view of the display device, FIG. 5 is a plan view of a face substrate shown in FIG. 4 as viewed from a back substrate side, and FIG. 6 is a cross-sectional view taken along a line I-I in FIG. 5.

In FIG. 4 to FIG. 6, symbol PN1 indicates a back panel, symbol PN2 indicates a face panel, and symbol MFL indicates a sealing frame. A vacuum envelope is constituted by laminating both panels PN1 and PN2 with the sealing frame MFL inserted there between and evacuating the inside of the laminated structure. In this embodiment, the back panel PN1 on which electron sources are formed constitutes an electron source device and the sealing frame MFL constitutes a connecting portion.

A large number of cathode lines are formed on an inner surface of a back substrate SUB1 which constitutes the back panel PN1 in a state that cathode lines extend in one direction (y direction) and are arranged in parallel in another direction (x direction) which intersects the y direction. A large number of electron sources are formed on the inner surface of the back substrate SUB1 in a state that the electron sources are electrically connected with cathode lines. Further, control electrodes MRG which are formed of a large number of ribbon-like metal thin plates and extend in the x direction and are arranged in parallel in the y direction are formed above the electron sources. A large number of through holes which allow electron beams to pass therethrough are formed in each control electrode MRG.

On the other hand, on an inner surface of a face substrate SUB2 which constitutes the face panel PN2, phosphor pixels R, G, B, a BM layer and an anode (not shown in the drawing) formed of a metal thin film are formed. The face panel PN2 is laminated to the back panel PN1 in the orthogonal direction (z direction) by way of the sealing frame MLF.

An insulation layer INS is interposed between the cathode lines which are formed on the back substrate SUB1 and the control electrodes MRD except for the above-mentioned through hole portions. Cathode line lead terminals CL-T are pulled out from the cathode lines, while control electrode lead terminals MRG-T are pulled out from the control electrodes MRG. Further, after laminating the back panel PN1 and the face panel PN2, the evacuation is performed. That is, the inside of a space defined by the back panel PN1, the face panel PN2 and the sealing frame MFL is evacuated to create a vacuum of, for example, 10⁻³ to 10⁻⁵ Pa.

The phosphor pixels R, G, B are formed on the face substrate SUB2, a BM layer having a light blocking property is formed between these phosphor pixels R, G, B, and the phosphor pixels R, G, B and the BM layer contain boron. This boron is, after forming the phosphor pixels R, G, B and the BM layer, contained or introduced into the phosphor pixels R, G, B and the BM layer by immersing the phosphor pixels R, G, B and the BM layer into an aqueous solution which is produced by diluting boron hydride [B(OH)₃] with pure water or the like. Further, these phosphor pixels R, G, Band BM layer have back-substrate-SUB-1 side thereof covered with a metal thin film (not shown in the drawing).

The phosphor pixels constitute one pixel with an arrangement of red (R), green (G), blue (B). The respective colors are defined by the BM layer. The BM layer is black conductor. The BM layer contributes to the prevention of the color slurring, the enhancement of contrast, the charge-up of the phosphor layer and the like.

As a substance which controls a resistance value of this BM layer, it is possible to use a metal alkoxide liquid which is used in the surface treatment of cathode ray tube or the like. As one example of the metal alkoxide liquid, a silicon alkoxide liquid can be used. In the silicon alkoxide liquid, tetra-ethoxy-silane is dissolved in ethanol which constitutes a solvent. When water and nitric acid are added to the silicon alkoxide liquid, the hydrolysis and the dehydration condensation reaction occur so that polysiloxane bonds are formed. The conductive particles are fetched in the polysiloxane bonds so that the BM layer can obtain the stable conductivity. Accordingly, it is possible to realize the charge countermeasure of the face panel PN2 to which the high voltage is applied. Here, the as a material of the BM layer, a material which is softened at a temperature of 400° C. to 450° C. is used and oxide such as chromium oxide (Cr₂O₃), iron oxide (Fe₂O₃) or the like may be added to give the light blocking property.

As the BM layer, a layer containing graphite as a main component which is equal to the layer used for forming the above-mentioned interior conductive layer is applicable.

Although both of the phosphor pixels R, G, B and BM layer contain boron in the above-mentioned configuration, either one of these members may contain boron in the same manner as the embodiment 1.

In this embodiment 2, at least one of the phosphor pixels and BM layer is configured to contain boron, it is possible to suppress a gas (gas which promotes oxidation) quantity in the inside of the panel. Accordingly, it is possible to prevent the deterioration of the cathodes thus realizing the prolonged lifetime of the display device.

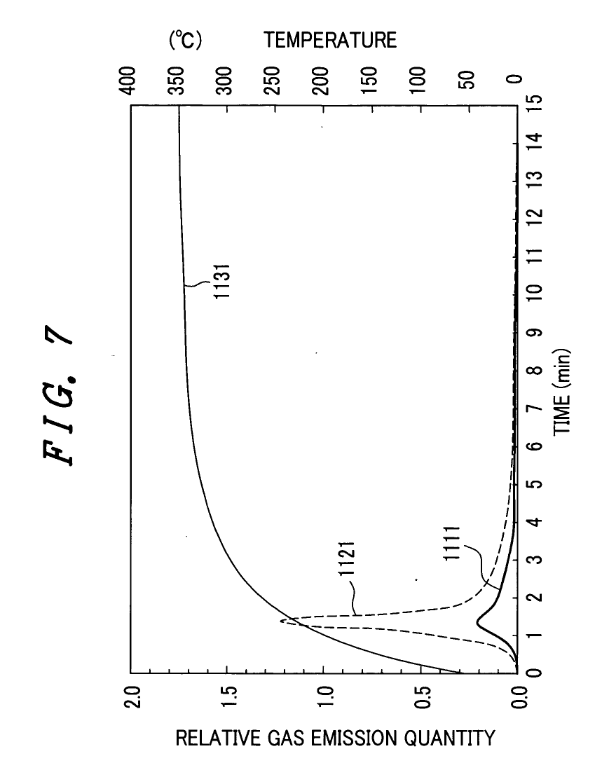

FIG. 7 is a view showing a result of the measurement of a gas emission quantity of the conductive film using a temperature-programmed desorption method (TDS) for explaining the display device of the present invention.

In FIG. 7, a bold solid line 1111 indicates a gas emission quantity curve of the present invention, a dotted line 1121 indicates a gas emission quantity curve of the conventional structure, and a solid line 1131 indicates a temperature curve.

In FIG. 7, the gas emission quantity is measured by simulating an evacuation step in cathode ray tube manufacturing steps, wherein a sample of the present invention and a sample having the conventional structure are respectively prepared in following manners and are compared with each other and evaluated. That is, the sample of the present invention is prepared such that a conductive film having the composition which contains graphite, potassium silicate, titanium oxide and other organic substances is applied to a glass substrate to which the heat treatment is applied, the conductive film is dried, and the conductive film is immersed in an aqueous solution which is produced by diluting boron hydride [B(OH)₃] having purity of 6N with pure water or the like by 100 times, and then is dried. On the other hand, the conductive film having the conventional structure is prepared by merely applying the above-mentioned conductive film to the glass substrate and drying the conductive film.

These samples are subjected to a comparison measurement by elevating temperature in accordance with the temperature curve indicated by the solid line 1131. As a result of the comparison measurement, with respect to the gas emission quantity of the present invention, the gas emission is substantially ceased or stopped within approximately 4 minutes as indicated by the bold solid line 1111 and, further, the gas emission quantity becomes 1090 Pa·L/g (Pascal·litter/gram)

To the contrary, in the conventional structure indicated by the dotted line 1121, it is confirmed that the gas emission continues for approximately eight minutes which is approximately twice as long as the gas emission time of the present invention. Further, the gas emission quantity also amounts to 3600 Pa·L/g which is well three times as large as the gas emission quantity of the present invention.

Accordingly, the conductive film of the present invention can shorten the gas emission time to one half or less of the gas emission time of the conductive film of the conventional structure and, at the same time, can also reduce the gas emission quantity to ⅓ or less of the gas emission quantity of the conductive film of the conventional structure.

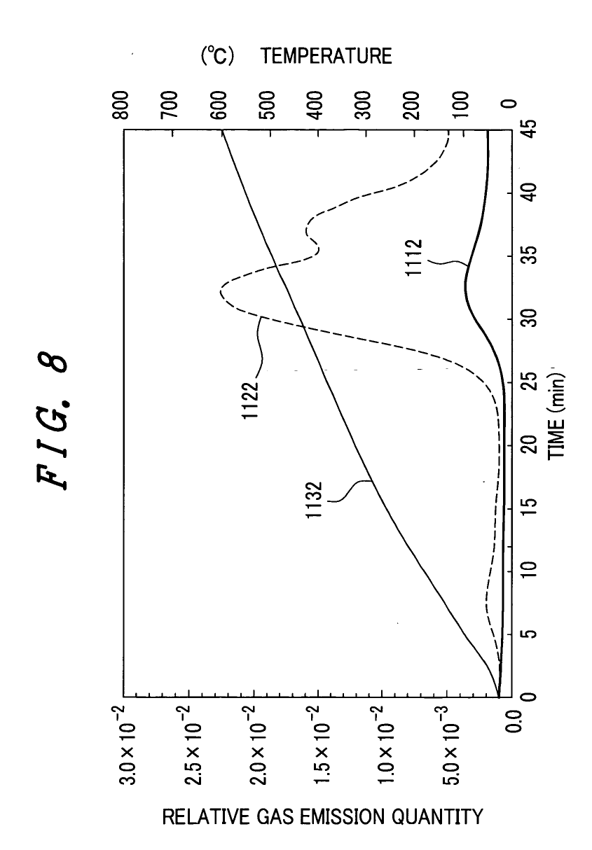

Next, in the same manner as FIG. 7, FIG. 8 is a view for explaining a result of the measurement of a gas emission quantity of a conductive film using a temperature-programmed desorption method (TDS). FIG. 8 simulates a case in which the cathode ray tube is operated.

The gas emission characteristics shown in FIG. 8 show a result when the samples shown in FIG. 7 whose gas emission characteristics are measured are held in a vacuum so as to lower the temperature of the samples to a room temperature and, in accordance with a temperature curve indicated by a solid line 1132, again, the temperature of the samples are elevated, and the comparison measurement is performed. Here, the temperature elevation speed is set at 13° C./min.

In FIG. 8, with respect to the sample of the present invention which is indicated by the bold solid line 1112, the gas emission starts when the temperature is raised to approximately 400° C. after starting the operation and assumes a peak value when the temperature is approximately 500° C. However, the value of the gas emission quantity is extremely small and exhibits approximately 180 Pa·L/g.

On the other hand, with respect to the sample having the conventional structure, as indicated by a dotted line 1122, the gas emission starts in the vicinity of 400° C. and assumes a maximum value at approximately 500° C. During this temperature elevation period of 100° C., the gas emission is extremely sharply increased continuously. Thereafter, when the temperature exceeds 500° C., the gas emission starts decreasing. However, the gas emission has a second peak in the vicinity of 550° C. That is, FIG. 8 teaches that gas emission quantity of the conventional structure becomes approximately 760 Pa·L/g which is approximately four times as large as the gas emission quantity of the present invention and the difference becomes more apparent when the bulb is operated.

The advantageous effects shown in FIG. 7 and FIG. 8 are substantially equal also with respect to the phosphor pixels. However, the brightness enhancing effect is also observed with respect to the phosphor pixels.

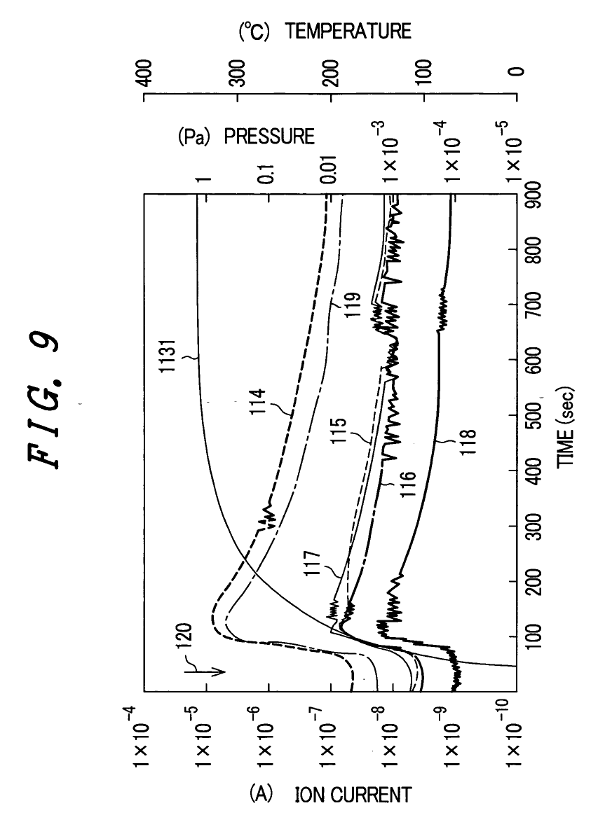

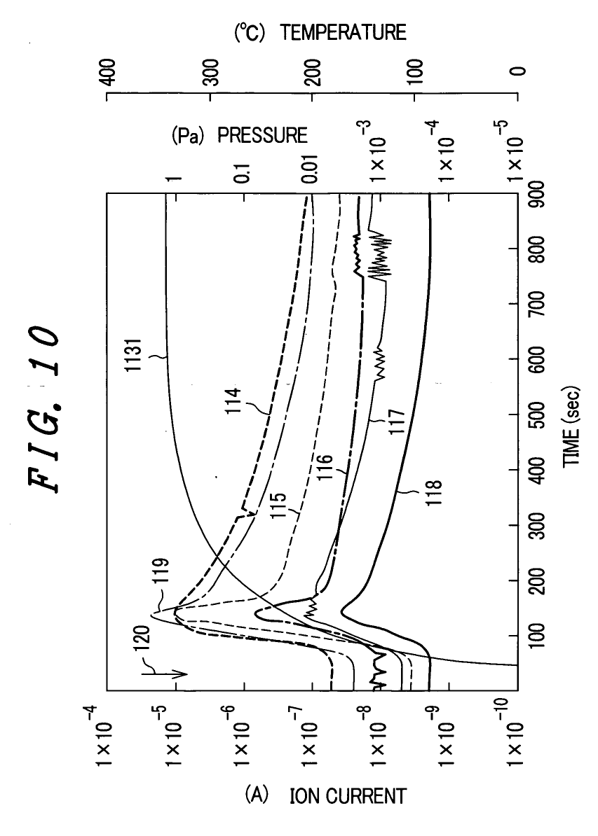

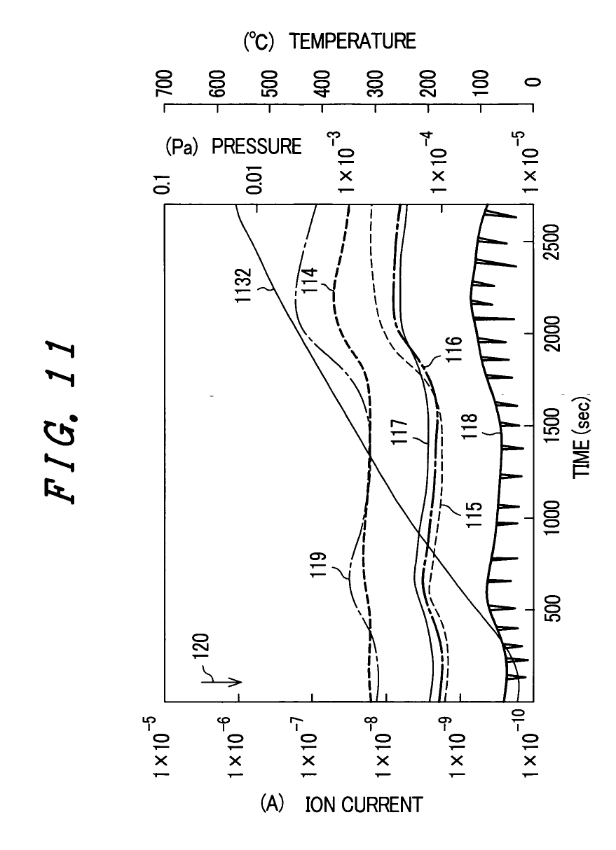

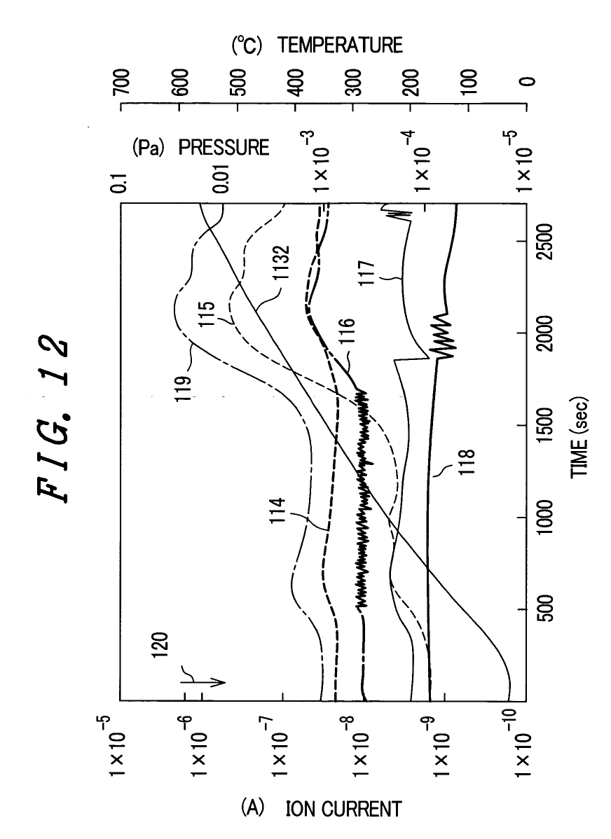

Next, FIG. 9 to FIG. 12 are views for explaining an emission gas content emitted from the conductive film, wherein FIG. 9 shows a case indicated by the bold solid line 1111 in FIG. 7, FIG. 10 shows a case indicated by the dotted line 1121 in FIG. 7, FIG. 11 shows a case indicated by the bold solid line 1112 in FIG. 8, and FIG. 12 shows a case indicated by the dotted line 1122 in FIG. 8.

In FIG. 9 to FIG. 12, a bold dotted line 114 indicates H₂O content, a fine dotted line 115 indicates a CO₂ content, a bold chain line 116 indicates a (N₂+CO) content, fine solid line 117 indicates a H₂ content, and a bold solid line 18 indicates an O₂ content, respectively. Further, a fine chain line 119 indicates a total pressure and an arrow 120 indicates a background value. The background value is a value of a gas content quantity which already exists in the tube before heating.

As can be clearly understood from FIG. 9 to FIG. 12, the present invention is largely different from the conventional structure with respect to two components consisting of the CO₂ content which in indicated by the fine dotted line 115 and the (N₂+CO) content which is indicated by the bold chain line 116 and this difference seems to constitute a factor which suppresses the gas emission quantity.

### Embodiment 3

Further, in the above-mentioned embodiments 1, 2, the phosphor pixels, the BM layer and the interior conductive film are configured to contain boron by immersing these elements to the boron aqueous solution. However, in place of immersing, according to a sample obtained by another embodiment in which the aqueous solution is applied to the phosphor pixels, the BM layer and the interior conductive film by spraying, it is possible to obtain the substantially equal gas emission suppression effect.

This maybe considered that, as mentioned previously, since the phosphor pixels, the BM layer and the interior conductive film have relatively porous surfaces and hence, these elements can easily fetch boron to the surfaces of the pixels and film whereby these elements can exhibit the gas emission suppression effect due to the action of boron which is present on the surface layers. Here, as means for allowing the phosphor pixels, the BM layer and the interior conductive film to contain boron, the example which uses the immersing of these elements into the diluted aqueous solution and the example which uses the spraying are named. However, it is also possible to adopt other method including a method which applies or forms boron using a brush and a method which adds and mixes boron into a film forming slurry. Further, in the immersing or coating method, a ratio of approximately 0.7 to 1.5 g of boron with respect to the 100 g(0° C.) water is practical. Further, a ratio of approximately 0.9 to 1.1 g of boron with respect to the 100 g(0° C.) is more preferable. On the other hand, in the method in which boron is preliminarily added to the pixels or film forming slurry, it is preferable to set the boron quantity higher than the above-mentioned ratio. Further, although the interior conductive film is formed or graphite, potassium silicate and titanium oxide and the like in the above-mentioned embodiments, the interior conductive film may be configured to contain other materials such as iron oxide and the like.

According to the present invention, since the phosphor pixels, the BM layer and the like are allowed to contain boron, it is possible to suppress the gas emission quantity from the interior conductive film whereby, it is possible to shorten an evacuation time at the time of manufacturing the display device thus realizing the enhancement of the operation efficiency and the reduction of a manufacturing cost.

1. A display device including a vacuum envelope which comprises:
a panel portion which forms a phosphor screen on an inner surface thereof;
a neck portion which is provided with an electron source; and
a funnel portion which connects the panel portion and the neck portion, wherein
a conductive film is formed on an inner surface of the funnel portion and the inner conductive film contains boron.

2. A display device comprising a phosphor screen which includes phosphor pixels, a black matrix film which surrounds the phosphor pixels and a metal thin film which covers the black matrix film and the phosphor pixels, and electron sources which emit electrons toward the phosphor screen in the inside of a vacuum envelope, wherein
the phosphor pixels or the black matrix film contains boron.

3. A display device according to claim 2, wherein the vacuum envelope includes a panel portion which has a phosphor screen, a neck portion which has the electron source, and a funnel portion which connects the neck portion and the panel portion.

4. A display device according to claim 2, wherein the vacuum envelope includes a flat face plate having the phosphor screen, a flat back substrate including the electron source, and a sealing frame which is interposed between peripheral portions of the back substrate and the face plate.

5. A display device comprising a phosphor screen which includes phosphor pixels, a black matrix film which surrounds the phosphor pixels and a metal thin film which covers the black matrix film and the phosphor pixels, and electron sources which emit electrons toward the phosphor screen in the inside of a vacuum envelope, wherein
the phosphor pixels or the black matrix film have surface layers thereof covered with boron.
